(19) United States
(12) Patent Application Publication
(10) Pub. No.: US 2021/0065668 A1
(43) Pub. Date: Mar. 4, 2021

(54) REUSABLE VIBRATION INDUCTOR STRUCTURE

(71) Applicant: Tzu-Chen Liu, Keelung City (TW)

(72) Inventor: Tzu-Chen Liu, Keelung City (TW)

(21) Appl. No.: 16/554,521

(22) Filed: Aug. 28, 2019

(51) Int. Cl. G10H 3/22; G10H 3/08

(52) U.S. Cl. CPC G10H 3/22; G10H 2220/461; G10H 3/08

(57) ABSTRACT

A reusable vibration inductor structure includes a vibration inducting sheet, Velcro tape and circular iron ring, wherein the Velcro tape of the same diameter is attached to a back of the vibration inducting sheet, the circular iron ring having a larger diameter is adapted to press against an outer rim of the Velcro tape, and an outer rim of the circular iron ring is equidistantly configured with a plurality of pressing tabs capable of being horizontally pressed back to clamp an outer rim of a front of the vibration inducting sheet with front ends thereof. Whereby, the present invention can be conveniently detached down and reattached to the surfaces of different percussion instruments.

### (a) TECHNICAL FIELD OF THE INVENTION

The present invention relates to a reusable vibration inductor structure, and more particularly to a device used on an electronic percussion instrument, capable of being attached to the surface of the instrument at will to emit different sounds.

### (b) DESCRIPTION OF THE PRIOR ART

General vibration inductors used on an electronic percussion instrument are arranged on the inducting area thereof; the vibration inductors can sense the vibration generated from the percussion instrument when being hit, and the speech recognition is then carried out by a host computer. Thereby, relative knocking sounds such as drums or cymbals are produced depending on the duration and magnitude of the vibration.

The aforementioned vibration inductors can only be used once and cannot be detached to use again; it is namely that they can only be fixed to and used on only one percussion instrument. But, the vibration inductors used in a special status need particular designs to allow them to be attached to and reused on other percussion instruments in order to let them be reused without affecting their sensitivity and structural integrity.

Referring to FIG. 1, a conventional vibration inductor 10 is formed by attaching a thin vibration sensing element 12 with a smaller diameter to a copper foil 11 with a larger diameter. But, the aforementioned combined body cannot withstand the forces of external distortion like a coin does. In order to guarantee that it is reusable on different hit objects, it is necessary to strengthen the toughness of its external structure to maintain its sensitivity,

### SUMMARY OF THE INVENTION

The present invention proposes a reusable vibration inductor structure, including a vibration inducting sheet, Velcro tape and circular iron ring, wherein the Velcro tape of the same diameter is attached to a back of the vibration inducting sheet, the circular iron ring having a larger diameter is adapted to press against an outer rim of the Velcro tape, and an outer rim of the circular iron ring is equidistantly configured with a plurality of pressing tabs capable of being horizontally pressed back to clamp an outer rim of a front of the vibration inducting sheet with front ends thereof.

### BRIEF DESCRIPTION OF THE DRAWINGS

FIG. 1 is a schematic view of a conventional vibration inducting sheet structure;

FIG. 2 is a schematic view of the front of a vibration inductor structure of the present invention;

FIG. 3 is a schematic view of the back of the vibration inductor structure of the present invention; and

FIG. 4 is a schematic view of a circular iron ring according to the present invention.

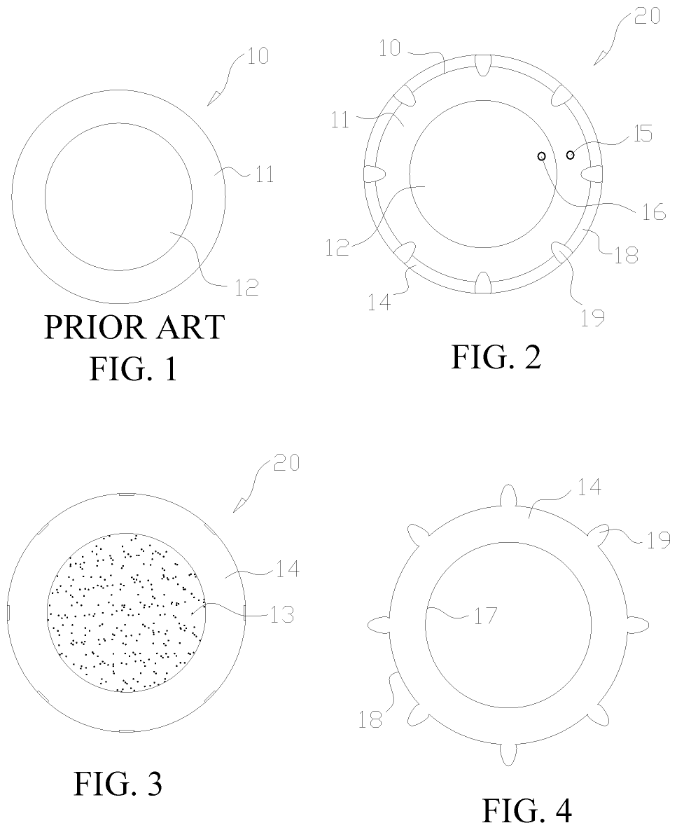

### DETAILED DESCRIPTION OF THE PREFERRED EMBODIMENTS

Referring to FIG. 2, which is a front view of a vibration inductor structure of the present invention, a vibration inductor structure 20 is constituted by a vibration inducting sheet 10, Velcro tape 13 (not shown in the figure) and Circular iron ring 14, where the vibration inducting sheet 10 is formed by a copper foil 11, the front inner circle of which a thin vibration sensing element 12 is attached to, which combines the both integrally with each other to form the vibration inducting sheet 10. Furthermore, the back of the copper foil 11 is further adhered to the back of a Velcro tape 13 of the same diameter.

Referring to FIG. 2 again, the vibration inducting sheet 10 is made by combining the copper foil 11 and thin vibration sensing element 12, and a signal transmission line weld point 15, 16 are respectively configured on the copper foil 11 and the vibration sensing element 12 for the welding of a transmission line to transmit vibration signals to a host computer (not shown in the figure).

Referring to FIG. 2 again, and referring to FIG. 3, which is a schematic view of the back of the present invention, the circular iron ring 14 with a larger diameter is pressed in advance against the outer rim of the front of the Velcro tape 13 having hairy hooks adhered to the vibration inducting sheet 10, and an outer rim 18 of the circular iron ring 14 is equidistantly configured with a plurality of pressing tabs 19, which are pressed back horizontally and then clamped to the outer rim of the vibration inducting sheet 10 with the front ends thereof, thereby allowing the middle circle portion of the Velcro tape 13 which is not pressed by the circular iron ring 14 on the back of the vibration inducting sheet 10 to be formed into a horizontal surface slightly protruded from the circular iron ring 14 so that the Velcro tape 13 can be easily adhered to a fine hair sheet (not shown in the figures) required to adhere to the pre-selected surface of a percussion instrument.

Referring to FIG. 4, which is a schematic view of a circular iron ring according to the present invention, and referring to FIGS. 2 and 3 again, because the diameter of the outer rim of the circular iron ring 14 is slightly larger than the one of the vibration inducting sheet 10, the diameter of the inner rim (i.e. the inner diameter of the circular iron ring 14) is also slightly larger than the one of the vibration sensing element 12, and the plurality of pressing tabs 19 are extended from the outer rim of the circular iron ring 14 so that the plurality of pressing tabs 19 can be horizontally pressed back to clamp the outer rim of the front of the vibration inducting sheet 10 with the front ends thereof to form the vibration inductor structure 20.

Because the vibration inducting sheet 10 is originally a very thin sensitive metal sheet, it cannot be abrasion-resistant, pressure-resistant and resistant to external distortion like a coin can; if it wants to have the same structural strength as a coin to be reused in different percussion instruments any time so as to guarantee its sensitivity, the vibration inductor structure 20 of the present invention must be used.

I claim:

1. A reusable vibration inductor structure, comprising a vibration inducting sheet, Velcro tape and circular iron ring, Wherein said Velcro tape of the same diameter is attached to a back of said vibration inducting sheet, said circular iron ring having a larger diameter is adapted to press against an outer rim of said Velcro tape, and an outer rim of said circular iron ring is equidistantly configured with a plurality of pressing tabs capable of being horizontally pressed back to clamp an outer rim of a front of said vibration inducting sheet with front ends thereof.

2. The structure according to claim 1, wherein an inner diameter of said circular iron ring is slightly greater than a diameter of a vibration sensing element configured on said vibration inducting sheet.
